(19) United States
(12) Patent Application Publication
(10) Pub. No.: US 2019/0256198 A1
(43) Pub. Date: Aug. 22, 2019

(54) AIRCRAFT WITH TWO FLOATS

(71) Applicant: Piotr JEUTÉ, Warszawa (PL)

(72) Inventor: Piotr JEUTÉ, Warszawa (PL)

(21) Appl. No.: 16/336,464

(22) PCT Filed: Sep. 30, 2017
(86) PCT No.: PCT/EP2017/074920

§ 371 Date: Mar. 25, 2019

(30) Foreign Application Priority Data
Oct. 7, 2016 (GB) 1617046.6
Oct. 7, 2016 (GB) 16461561.9

(51) Int. Cl. B64C 25/66; B64C 35/00

(52) U.S. Cl. CPC B64C 25/66; B64C 35/008

(57) ABSTRACT

An aircraft having a longitudinal axis determining a fore-aft direction, comprising at least two floats configured to support the aircraft on a ground medium located below the floats with a ground-facing side of the floats, wherein each float comprises: a first support wheel and a second support wheel, the first support wheel being located within the float further in the fore direction than the second support wheel, wherein at least the first support wheel is located within the float so that it protrudes partly out of the ground-facing side of the float; wherein the first support wheel protrudes out of the ground-facing side of the float so that an angle α between a first line z1 tangential to a float profile line, intersecting the float profile line in front of the first support wheel on the ground-facing side, which has the smallest angle with respect to the horizontal axis of the float, and which intersects the profile line within a circle C concentric with the first support wheel and of a radius 2R being two times larger than a radius R of the first support wheel, the first line z1 intersecting the circumference of the first support wheel in point B, and a second line z2 tangential to the circumference of the first support wheel point B, wherein the first line z1 and the second line z2 are comprised within the same, vertical plane, which is parallel to the fore-aft direction, is comprised in a range 145°-175°.

### TECHNICAL FIELD

The present invention relates to an aircraft with an amphibian float, and in particular to an all-terrain aircraft comprising amphibian float with a suspension system.

### BACKGROUND

The amphibian aircraft floats are typically designed to allow landing on water with wheels up and to allow landing on a runway with wheels down. In most of amphibian applications wheels of the landing gear to be used on a surface other than water (including deep snow) are retractable for water operations. Such retractable wheels are usually smaller and lighter than regular, non-retractable aircraft wheels. On the other hand, bush aircrafts designed to operate not only on runways, but also on unprepared landing spots, are usually fitted with robust landing gear and big size wheels. Small wheels attached to moving elements of landing gear in most of amphibious aircrafts limit their ability to land on less than perfect runways and substantially prevent safe landing on unprepared ground.

Using retractable amphibious landing gear requires attention from the pilot in command and checking of the appropriate configuration of landing gear before each landing. Landing with retracted wheels on the ground, as well as landing without retracted wheels on water, have been leading to a number of incidents, which often result in damages to the aircraft.

Landing in wild environments, and in all cases where ground medium might prove to be unstable and unpredictable, involves a risk of damaging the float and the aircraft, which could lead to injury or death of the crew. It would be desirable to design and implement an amphibious landing gear which would allow the aircraft to land on different kinds of surface, such as choppy water, snow, sand, mud and possibly uneven or rough terrains, while maintaining error-proof and reliable operation.

U.S. Pat. No. 6,464,168 discloses a landing gear system for an aircraft comprising a pair of legs, each having a wheel at a distal end, a pivot point associated with each leg for allowing each leg to follow an arc-shaped path between a deployed position and a retracted position, one of the legs passing in front of the other while moving from the deployed position to the retracted position, and a linking assembly disposed between the legs for ensuring that the legs move from the deployed position to the retracted position in unison. The system comprises pods, wherein each pod receives the wheel of the leg assemblies disposed opposite the pod. The wheel may be replaced by a ski, float, or other ground contact member for support during landing and takeoff of the aircraft. Such replacement would not be possible during flight though. The pod in itself does not provide any buoyancy. Moreover, actuation means are necessary for moving the wheels between the deployed and the retracted positions.

U.S. Pat. No. 2,964,271 discloses an amphibian aircraft in which main ground landing gear retracts substantially completely within a stub wing extending between floats. The floats are buoyant and serve to support the entire weight of the aircraft when the latter is water borne. Wheels of the landing gear may be moved between ground contacting position in which they extend below and adjacent to the floats, and retracted position in which they lie substantially wholly within the airfoil contour of the stub wing. This kind of wheel and suspension design does not provide the sufficient rough terrain potential for the aircraft due to the limited size of the wheel diameter and limited shock absorbing and dumping characteristics of the suspension.

U.S. Pat. No. 2,077,526 discloses a system for connecting floats of a seaplane and the body such as the fuselage or a wing of the latter, which is configured in such a manner as to deaden the shocks of the float against a liquid surface upon landing on water. The system comprises shock absorbers inclined to a suitable extent relatively to the vertical. However, this system does not present amphibian solution and does not seem to allow the universal amphibian application with sufficient space for larger diameter wheels installation. Adding wheels of the size sufficient for non-retractable, all terrain application, apart from possible collision with the float suspension gear, would also add even more aerodynamic drag, which for the solution presented in the cited patent would already be comparatively high, even without additional big wheels.

A JP patent JP2006224686 discloses a system alternative to U.S. Pat. No. 2,077,526, also providing suspension gear for the float aircraft. Similarly, adding the all-terrain non-retractable wheels in this case would add a significant aerodynamic drag to an already aerodynamically-poor design. Described suspension does not allow individual operation of each float. This limits the absorbing performance of the landing gear on most demanding terrains.

A U.S. Pat. No. 1,916,413 discloses an amphibian aircraft having a central float and two side floats housing wheels. Each of the side floats houses a single wheel, which protrudes substantially from the float and its angular relationships with respect to the float are outside the relationsip defined for the present invention. Therefore, that float is not able to achieve the advantages of the present invention, in particular with respect to the aspect related to landing on variable surfaces, especially on water.

A GB patent GB412038 discloses an amphibian landing gear for an aircraft, comprising landing wheels and landing pontoons adapted for alternative use in landing on the ground or on the water. The ambibian landing gear comprises an arrangement for reducing the resistance caused by the wheel well by providing a channel extending rearwardly from the wheel well. However, the wheel protrudes substantially from the float and its angular relationships with respect to the float are outside the relationsip defined for the present invention. Therefore, that float is not able to achieve the advantages of the present invention, in particular with respect to the aspect related to landing on variable surfaces, especially on water.

A U.S. Pat. No. 1747696 discloses a retraceable wheel for pontoons of amphibian airplanes. Each of the side floats houses a single wheel, which protrudes substantially from the float and its angular relationships with respect to the float are outside the relationsip defined for the present invention. Therefore, that float is not able to achieve the advantages of the present invention, in particular with respect to the aspect related to landing on variable surfaces, especially on water.

All cited aircraft float designs, as well as many other examples of amphibious floats, would not allow for landing on varying kinds of surface. Furthermore, they would not allow for operation on different kinds of landing surface in the same, unchanging landing configuration.

### SUMMARY

There is therefore a need to provide an aircraft with a float that would allow to limit the risk of damaging of the float and/or of the aircraft during landing, as well as to improve a comfort and ease of landing and taking-off from varying ground medium.

The additional objective of presented invention is an all-terrain landing gear comprising fixed wheels that would allow for operation in areas where there may be water, land or snow in mixed, unknown proportions, so that neither straight floats nor traditional amphibious systems with usually small extended wheels may work well enough for a predictable, safe landing.

There is disclosed an aircraft having a longitudinal axis determining a fore-aft direction, comprising at least two floats configured to support the aircraft on a ground medium located below the floats with a ground-facing side of the floats, wherein each float comprises: a first support wheel and a second support wheel, the first support wheel being located within the float further in the fore direction than the second support wheel, wherein at least the first support wheel is located within the float so that it protrudes partly out of the ground-facing side of the float; wherein the first support wheel protrudes out of the ground-facing side of the float so that an angle α between a first line z1 tangential to a float profile line, intersecting the float profile line in front of the first support wheel on the ground-facing side, which has the smallest angle with respect to the horizontal axis of the float, and which intersects the profile line within a circle C concentric with the first support wheel and of a radius 2R being two times larger than a radius R of the first support wheel, the first line z1 intersecting the circumference of the first support wheel in point B, and a second line z2 tangential to the circumference of the first support wheel at point B, wherein the first line z1 and the second line z2 are comprised within the same, vertical plane, which is parallel to the fore-aft direction, is comprised in a range 145°-175°.

The float can be movably attached to the aircraft via a suspension, so that upon contacting the ground medium, the float can move essentially upwards and aftwards in relation to the aircraft, and upon detaching the float from the ground medium, the float can move essentially downwards and forwards in relation to the aircraft, wherein the suspension can comprise at least two shock absorbers configured to operate obliquely with respect to the fore-aft direction.

The suspension can be at least partially shielded by a fairing.

The float can be adapted for removal of the first support wheel from the side of the float opposite to its ground-facing side.

The floats can be movable independently to each other with respect to the aircraft.

The floats can be adapted to move exclusively in a vertical plane.

The second support wheel can be controllable so as to direct the aircraft while driving on the ground medium.

Both the first and the second support wheels can be partly encompassed within the float.

### BRIEF DESCRIPTION OF DRAWINGS

The aircraft with the float is presented by means of example embodiments in a drawing, in which:

FIGS. 1a-1c show the float in the first embodiment during flight,

FIGS. 2a-2c show the float in the first embodiment during contact with ground medium,

FIG. 3 shows in more detail the relation between the first support wheel and the float,

FIGS. 4a, 4b show the float in the second embodiment during flight,

FIGS. 5a, 5b show the float in the second embodiment during contact with ground medium,

FIG. 6 shows a suspension of the float of the first embodiment,

FIG. 7 shows a suspension of the float of the second embodiment,

FIGS. 8a-8d show the first example of an aircraft with the float during flight,

FIGS. 9a-9d show the first example of an aircraft with the float during contact with ground medium,

FIGS. 10a-10d show the second example of an aircraft with the float during flight,

FIGS. 11a-11d show the second example of an aircraft with the float during contact with ground medium.

### DETAILED DESCRIPTION

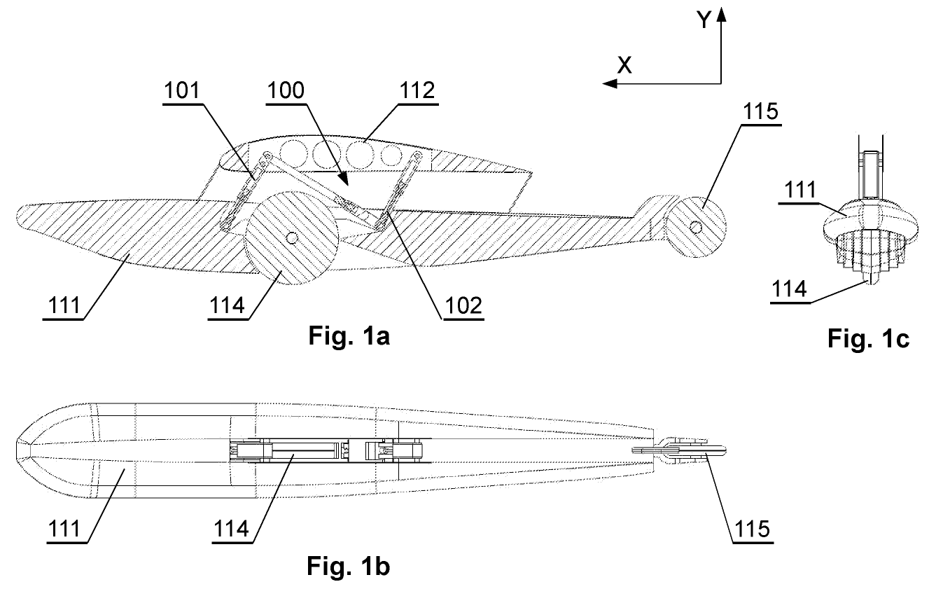

FIGS. 1a-1c show a float 111 for an aircraft in the first embodiment, during flight. FIG. 1a presents a float 111, attached to a wing 112 of the aircraft, in a cross-sectional view. The float 111 is attached to the wing 112 so that the float 111 is beneath the wing 112 and allows supporting the aircraft on a ground medium located below the float 111 with (on) ground-facing side of the float, e.g. by providing suitable buoyancy. Examples of such ground medium are: water, snow, marsh etc. The longitudinal axis of the aircraft determines a fore-aft direction, indicated throughout the figures as the X axis. The Y axis represents upward-downward direction. In any case, it is generally assumed that a downward direction points towards the ground medium, and an upward direction points in the opposite direction with respect to the downward direction, that is away from the ground medium.

Each of these floats 111 comprises first and second support wheels 114, 115. The first support wheel 114 is located within the float 111 further in the fore direction than the second support wheel 115, wherein at least the first support wheel 114 is located within the float 111 so that it protrudes partly out of the ground-facing side of the float 111. Alternatively, both the first and the second support wheels 114, 115 can be partly encompassed within the float. The second support wheel 115 is controllable so as to direct the aircraft while driving on the ground medium.

The float 111 is attached to the wing 112 movably via a suspension 100. Consequently, the float 111 is not rigidly connected to the aircraft. The suspension 100 is configured to cushion the possible landing impact to the airframe and to damp said movement of the float 111. A fuselage or a wing of the aircraft can be taken as a point of reference for the movement. At least two floats 111 will be attached to the wing or the fuselage of the aircraft.

FIGS. 1a-1c present the float during flight, above the ground medium, wherein the suspension 100 is in fully extended configuration. The suspension 100 preferably comprises at least two shock absorbers—a first shock absorber 101 and a second shock absorber 102. Both shock absorbers 101, 102 are arranged in parallel to each other, obliquely with respect to the fore-aft direction. In other words, the damping action of the shock absorbers 101, 102 is orientated at an angle acute (or obtuse) with respect to both horizontal axis X (i.e. fore-aft direction) and vertical axis Y (i.e. upward-downward direction).

FIG. 1b shows the float 111 in a top view. The float 111 is adapted for removal of the wheel 114 from the side of the float 111 opposite to the ground medium. The proposed design would not make it practical for the wheel 114 to be removable sidewise. In the presented invention the wheel 114 is removable through a specially designed slot in the float 111, the mounting gear and the wing. The wheel replacement can be executed by first supporting the float somewhat higher than when resting on installed wheel, and then by removing the wheel through the top. Next, a replacement wheel is inserted into the slot of the float 111. Fixing screws can be normally enclosed by means of fairing 116.

FIG. 1c shows the shape of the float 111 in a front view. The shape is suitable for flight both in the air and movement in and/or on the ground medium, as it minimizes the drag. Preferably, the shape of the float 111 is symmetrical in cross-section. In other words, the float has a plane of symmetry parallel to its longitudinal axis.

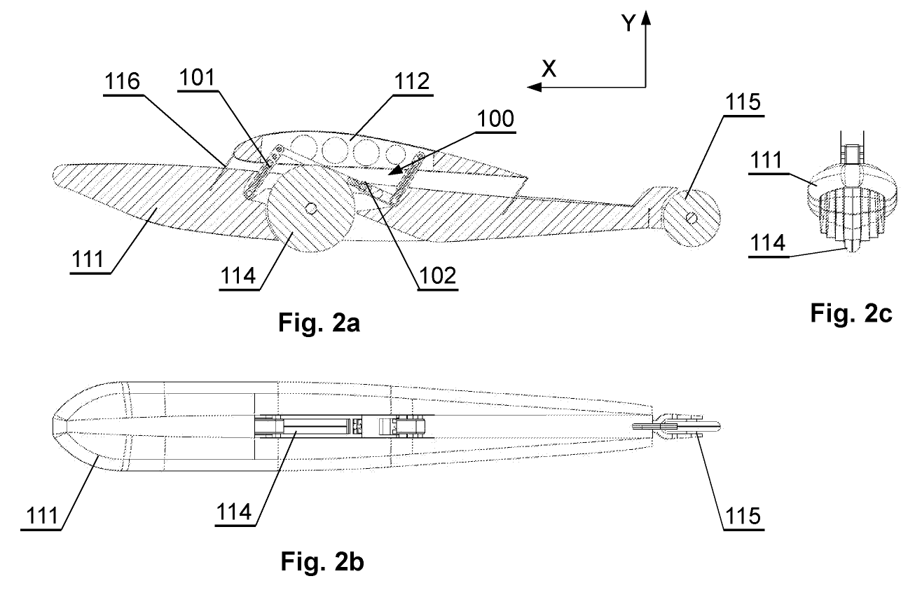

FIG. 2a-2c show the float 111 of the first embodiment during contact with a ground medium. The suspension 100 contracts due to movement of pistons of the shock absorbers 101, 102 within cylinders. Consequently, the float 111 moves towards the aircraft in the upward and aftward direction.

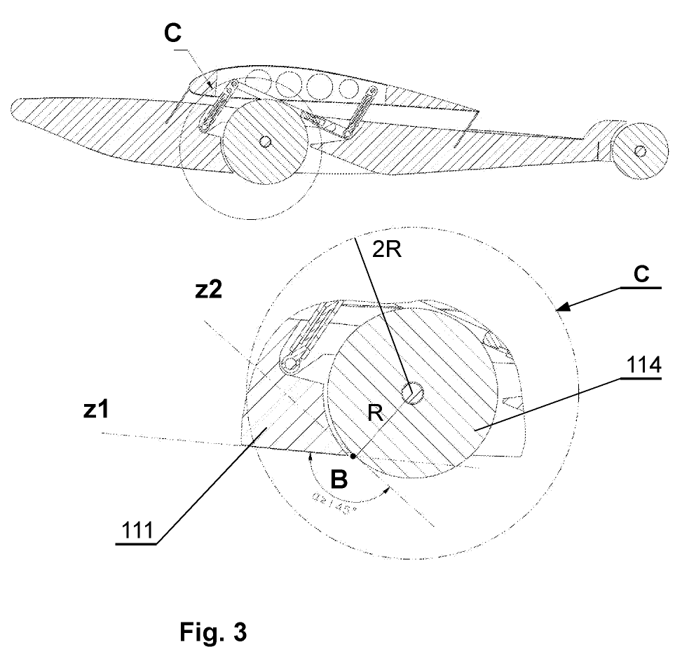

FIG. 3 shows in more detail the relation between the first support wheel 114 and the float 111. The first support wheel 114 protrudes out of the ground-facing side of the float 111.

The extent of the protrusion of the first support wheel 114 from the float 111 is described using an angle α, which is defined with help of lines z1 and z2. The first line z1 and the second line z2 are comprised within the same, vertical plane, which is parallel to the fore-aft direction axis X and coplanar with the symmetry plane of the float.

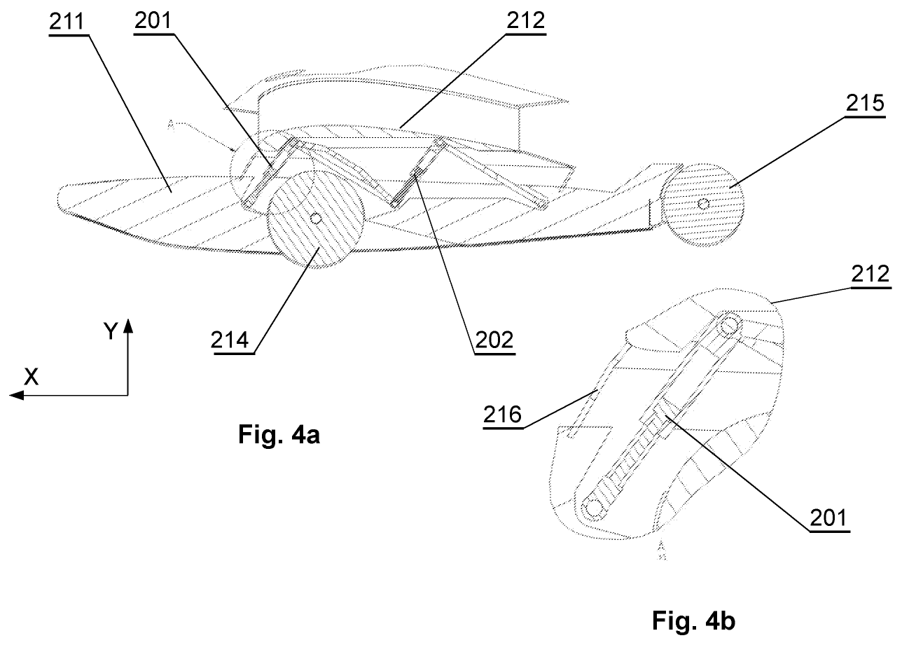

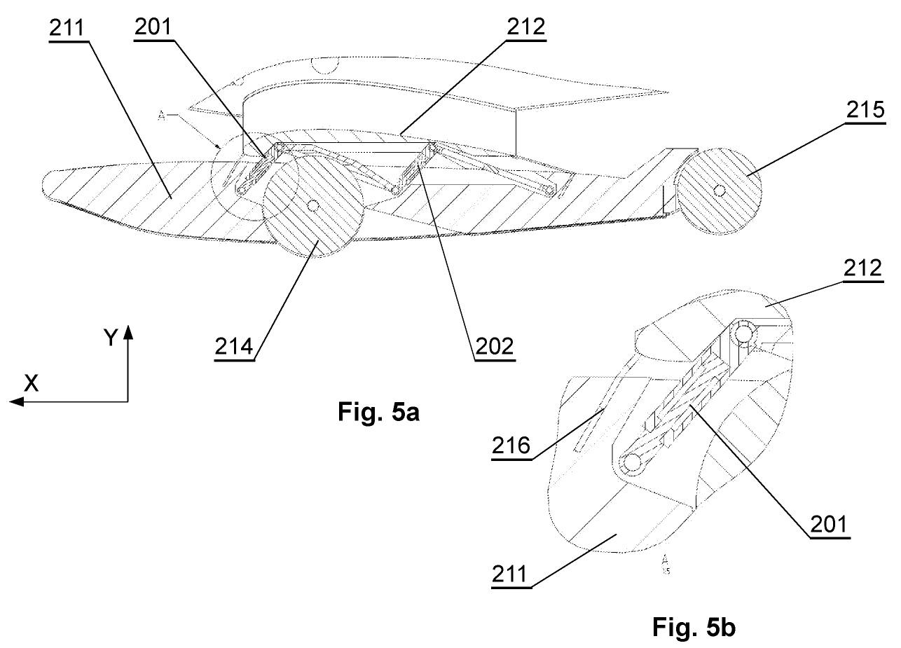

The first line z1 is tangential to a float profile line (float profile outline) and intersects said profile line in front of the first support wheel 114 on the ground-facing side of the float, preferably in its lowest portion. For this purpose, a float profile line (fragment of it) is selected within the longitudinal section which has the smallest angle with respect to the horizontal axis of the float, and is located within a circle C. It is possible for this selected line to be parallel to the horizontal axis X—in such case, the first line z1 is then co-linear with this fragment. Circle C is concentric with the first support wheel 114 and has a radius 2R being two times larger than a radius R of the first support wheel 114. The float profile line lies in the same plane as lines z1 and z2, and defines the floats outline within this plane. The first line z1 intersects the circumference of the first support wheel 114 in point B. The second line z2 is tangential to the circumference of the first support wheel 114 at point B. The angle α between the first line z1 and the second line z2 is comprised in a range 145°-175°. The applicant has recognized this value as a most preferable for operation during landing and taking off from various ground mediums. This relation mutatis mutandis to the second embodiment, which is described with reference to FIG. 4a-4b and FIG. 5a-5B.

The float with wheels defined as above is designed in such a way in order to disturb the water flow during water operations to a very small extent. This enables landing in and taking-off from water and ground in the same landing configuration, without the need to operate the wheels. At the same time, the drag generated by the wheel during water operations, as well as during flight, is minimized.

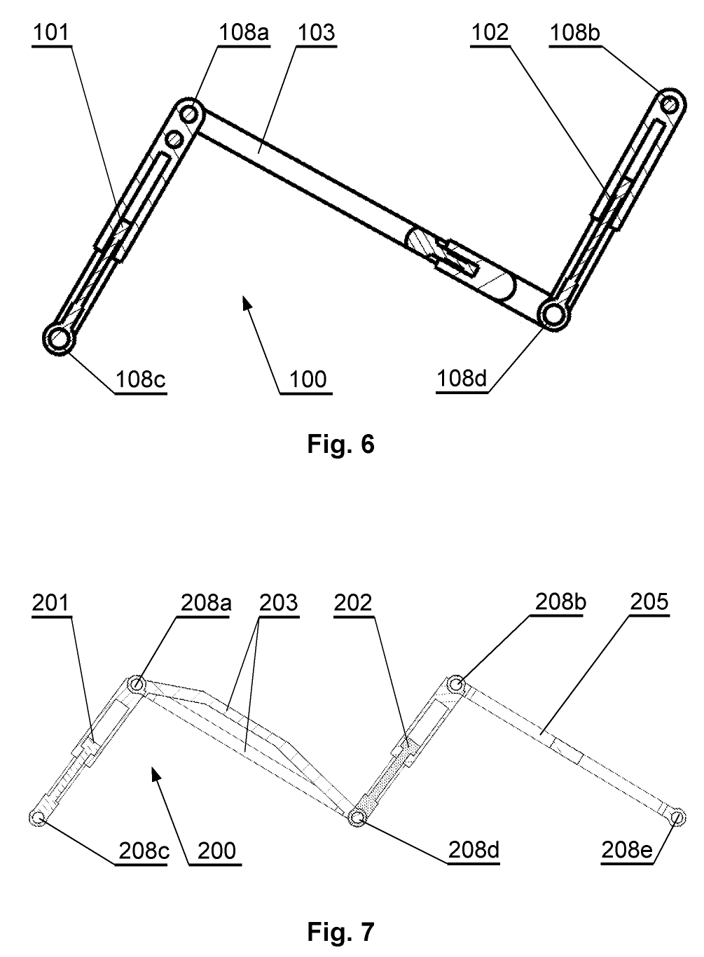

FIGS. 4a-4b and 5a-5b show the float 211 in a second embodiment. FIGS. 4a-4b show the float 211 during flight, in a fully extended configuration, and FIGS. 5a-5b show the float 211 during contact with ground medium, in a contracted configuration. The float 211 and support wheels 214, 215, the first and the second shock absorbers 201, 202 are arranged analogously to the first embodiment. The difference is a modified design of the suspension 200, as it will further be described with reference to FIGS. 6 and 7. In both embodiments a fairing 116, 216 has been implemented. The fairing 116, 216 shields the suspension elements, limiting their drag, and protects them against damaging. It can be any suitable fairing carried out according to known prior art solutions.

FIG. 5a, 5b show the float 211 in the second embodiment during contact with a ground medium. The suspension 200 contracts due to movement of pistons of the shock absorbers 201, 202 within cylinders. Consequently, the float 211 moves towards the aircraft in the upward and aftward direction.

FIG. 6 presents suspension 100 in a first embodiment. As stated above, in most cases there are two floats 111 connected to the aircraft. Consequently, each float 111 comprises at least one set of suspension 100 depicted in FIG. 6. The suspension 100 comprises the first shock absorber 101 connected to the float 111 in point 108c and adapted to be connected to the aircraft in joint 108a, for example to its wing. The suspension means 100 further comprise the second shock absorber 102, connected to the float 111 in point 108d and adapted to be connected to the aircraft in joint 108b. The first and the second shock absorbers are fixed with respect to each other by means of a rod 103, connected in points 108a and 108d. It serves also a stabilizing purpose.

FIG. 7 shows a suspension 200 of the float of the second embodiment. The suspension 200 comprises the first shock absorber 201 connected to the float 211 in point 208c and adapted to be connected to the aircraft in joint 208a, for example to its wing. The suspension means 200 further comprise the second shock absorber 202, connected to the float 211 in point 208d and adapted to be connected to the aircraft in joint 208b. The first and the second shock absorbers are fixed with respect to each other by means of a single or multiple rods 203, connected in points 208a and 208d which serve also a stabilizing purpose. Rods 203 can be shaped (curved) so as to accommodate the first support wheel within the suspension. To further stabilize the structure, a second rod 205 is provided, which connects point 208b of the aircraft with the float 211 in point 208e. The second rod 205 is parallel to the first rod 203.

Preferably, the floats 111, 211 are adapted to move exclusively in a vertical plane, e.g. by means by vertically aligning the shock absorbers. This has an effect of more predictable operation during landing and taking off.

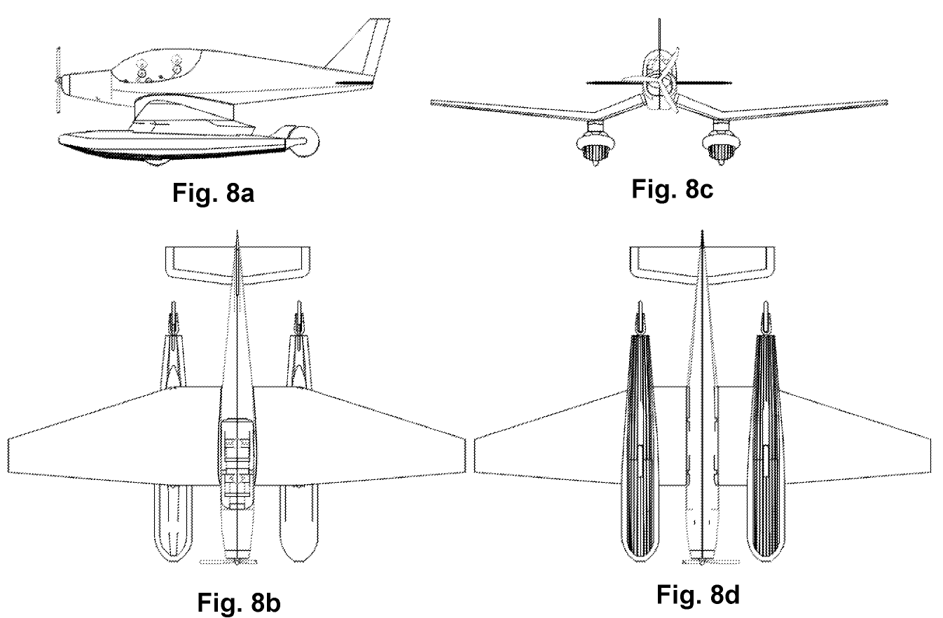

FIGS. 8a-8d show the first example of an aircraft with the float during flight.

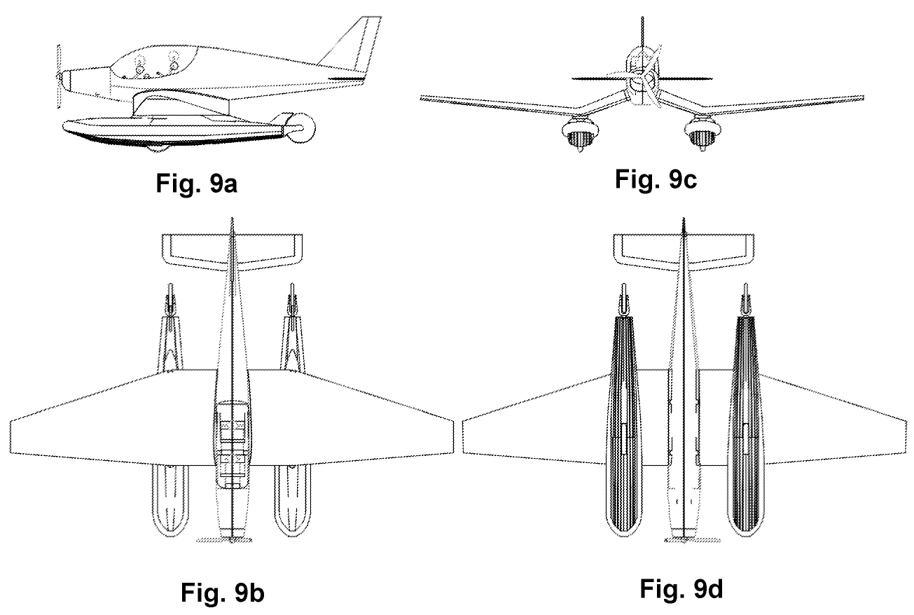

FIGS. 9a-9d show the first example of an aircraft with the float during contact with ground medium.

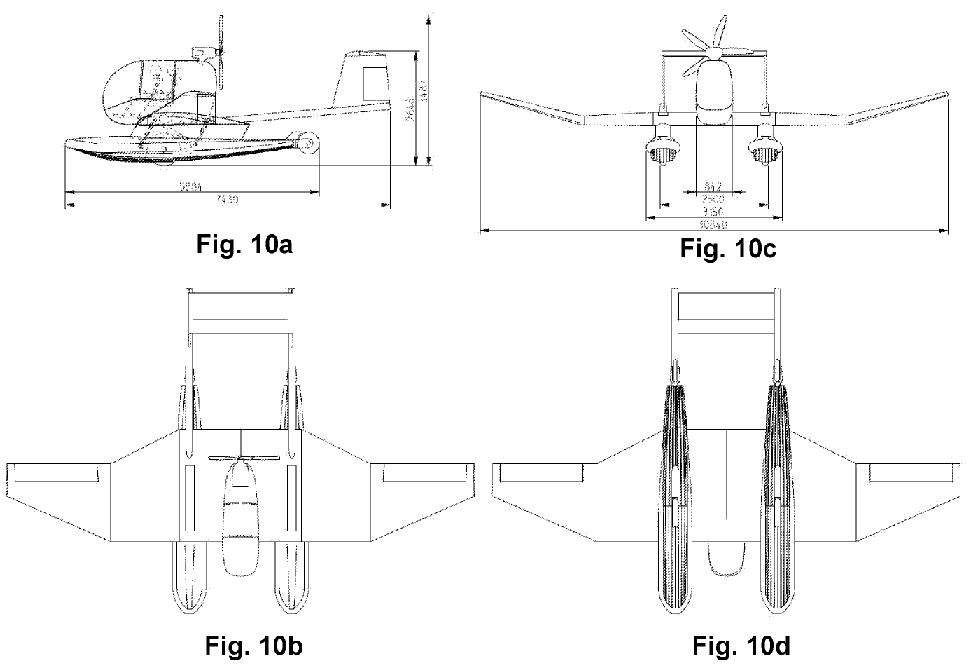

FIGS. 10a-10d show the second example of an aircraft with the float during flight.

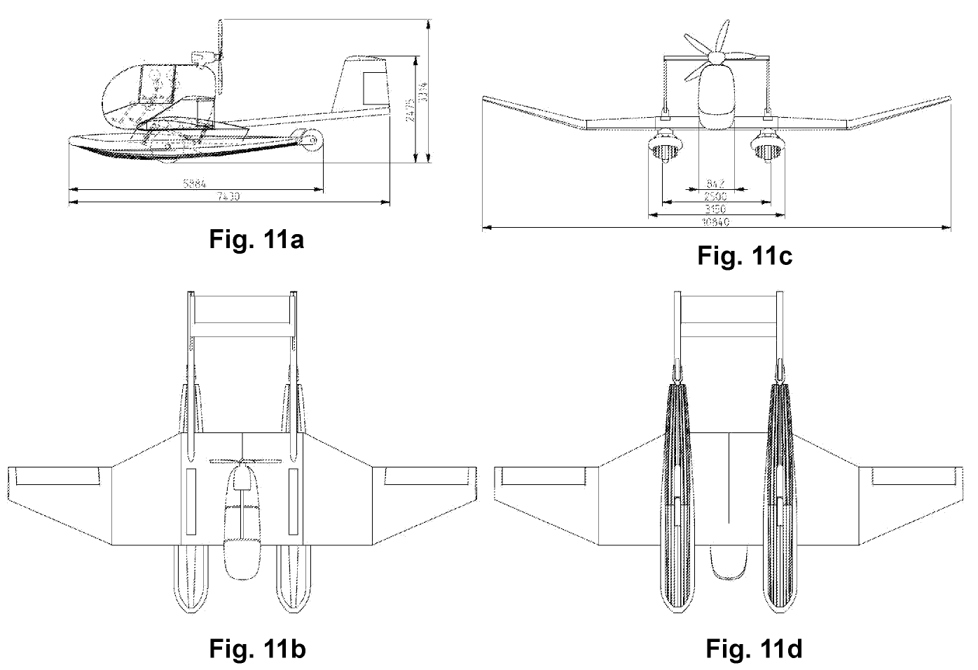

FIGS. 11a-11d show the second example of an aircraft with the float during contact with ground medium.

The additional benefit of presented solution is that it constitutes a mistake-proof landing system, which does not require pilot's attention to choose and check the appropriate configuration of landing gear on the approach. The presented configuration remains unchanged for all kinds of terrain ever possible for any airplane to land on.

The above described design includes big size wheels, suspension with damping and possibly long travel of shock absorbers, as well as floats prepared for choppy waters, deep snow or high grass. Such combination allows to achieve all discussed advantages.

1. An aircraft having a longitudinal axis determining a fore-aft direction, comprising at least two floats configured to support the aircraft on a ground medium located below the at least two floats with a ground-facing side of the at least two floats, wherein each of at least two floats comprises:
a first support wheel and a second support wheel, the first support wheel being located within the float further in the fore-aft direction than the second support wheel, wherein at least the first support wheel is located within the float so that it protrudes partly out of the ground-facing side of the float;
wherein the first support wheel protrudes out of the ground-facing side of the float so that an angle between
a first line tangential to a float profile line, intersecting the float profile line in front of the first support wheel on the ground-facing side, which has the smallest angle with respect to a horizontal axis of the float, and which intersects the float profile line within a circle concentric with the first support wheel and of a radius being two times larger than a radius of the first support wheel, the first line intersecting a circumference of the first support wheel at an intersection point,
and a second line tangential to the circumference of the first support wheel at the intersection point,
wherein the first line and the second line are comprised within the same, vertical plane, which is parallel to the fore-aft direction,
comprises an angle of between 145° and 175°.

2. The aircraft according to claim 1, wherein the float is movably attached to the aircraft via a suspension, so that upon contacting the ground medium, the float moves essentially upwards and aftwards in relation to the aircraft, and upon detaching the float from the ground medium, the float moves essentially downwards and forwards in relation to the aircraft, wherein the suspension comprises at least two shock absorbers configured to operate obliquely with respect to the fore-aft direction.

3. The aircraft according to claim 2, wherein the suspension is at least partially shielded by a fairing.

4. The aircraft according to claim 1, wherein the float is adapted for removal of the first support wheel from the side of the float opposite to its ground-facing side.

5. The aircraft according to claim 1, wherein the floats are movable independently to each other with respect to the aircraft.

6. The aircraft according to claim 1, wherein the floats are adapted to move exclusively in a vertical plane.

7. The aircraft according to claim 1, wherein the second support wheel is controllable so as to direct the aircraft while driving on the ground medium.

8. The aircraft according to claim 1, wherein both the first and the second support wheels are partly encompassed within the float.
